(19) United States
(12) Patent Application Publication
(10) Pub. No.: US 2012/0197661 A1
(43) Pub. Date: Aug. 2, 2012

(54) Managing system for health care plan and managing method for the same

(75) Inventors: Jiunn-Rong CHEN, Tainan City (TW); Shiu-Min Liao, Tainan City (TW); Chun-Lin Juan, Tainan City (TW); Cheng-Nan Kuo, Tainan City (TW)

(73) Assignee: Yuekang HealthCare Management Consultants, Inc.

(21) Appl. No.: 13/360,802

(22) Filed: Jan. 29, 2012

(30) Foreign Application Priority Data
Jan. 31, 2011 (TW) 100103666

(51) Int. Cl. G06Q 50/22

(52) U.S. Cl. 705/2

(57) ABSTRACT

A managing system for health care plan includes a server and a database connected to the server. The server hosts a website thereon, and the database stores disease data of at least one care recipient, and stores at least one health care plan template. When one of the disease data of the care recipient is selected on the website, the care provider selects one of the health care plan templates corresponding to the selected disease data, and applies the selected health care plan template to a dedicated calendar of the care recipient. Therefore, events of the health care plan template are then displayed on the calendar from a specific starting date.

### BACKGROUND OF THE INVENTION

1. Field of the Invention

The invention relates to a managing system and managing method, in particular to a managing system and managing method for instituting health care plans of a care recipient on a network environment.

2. Description of the Related Art

Traditionally a doctor will provide advice and or instruction to a patient after making a diagnosis, for example, exercise every day, or measure and record blood pressure every two days, or revisit the clinic once per week. However, patients are often careless about the exact date/time for taking medication or remember when is the next clinic appointment time. Hence the therapeutic efficacy is reduced.

Further, until the doctor completes the current visit's diagnosis the patient generally cannot estimate the date and or time for next appointment, which can often result in conflicting scheduling for the patient. Sometimes the patient even forgets the date and or time for next doctor appointment. Therefore, hospital usually tries to remind patient of their next visit date and time by telephone call or short message.

However, the reminding telephone call or short message from hospital usually only reminds the patients of the date for next visit, but it is insufficient in terms of providing detailed information for the event, examination, or procedure such as blood tests, physical exams and or radiographs. The patient is not reminded of specific alerts for diagnostic procedures in next visit, for example, whether or not to maintain fasting for 8 hours before the blood test. Therefore, the patient may not have proper preparation for the diagnostic procedure due to limited information in the reminding telephone call or short message.

Therefore, there is a need to contrive a novel health care system. The system will comprise of numerous health care plans corresponding to patient's diseases and it can also provide sufficient information in multifarious methods to remind the patient how to proceed and adhere to the health care plan, which results in augmented therapeutic efficiency.

### SUMMARY OF THE INVENTION

The object of present invention is to provide a managing system for health care plan and managing method for the same. The user, care provider or care recipient, may directly apply a health care plan template to a care recipient profile and display the health care plan events and items on a calendar whereby the care recipient can easily query each of the events, items of event and notices of the item on the system website.

It is another object of present invention to provide a managing system for health care plan and managing method for the same which delivers the information comprising the event title and the date of the event as well as the item title and the notices of the item to the care recipient before the occurrence date of the event.

In order to achieve the above object, the present invention comprises a server and a database operatively connected to the server. The server hosts a website thereon. The database stores at least one disease data of the care recipient and at least one health care plan template. When one of the disease data of the care recipient on the website is selected, the care provider can choose one of the health care plan template, and apply the chosen health care plan template to a dedicated calendar of the care recipient, and after a starting date is set, system displays the corresponding health care plan template on the calendar from the starting date. Further, the system can deliver the necessary information to remind the care recipient before the date of the event.

In comparison with prior art, the managing system and managing method of the invention has the advantage of directly applying an established health care plan template to a dedicated calendar according to the selected disease data. Therefore, the schedule for all events can be automatically set with specific dates and is not limited by whether the preceding event has completed.

Furthermore, the care recipient can see the entire plan on their dedicated calendar enabling care recipient to clearly see all the dates which includes every event, item, notice and all other relevant information. The will enable the care recipient to reduce time scheduling conflicts and avoid missing appointments and also be alerted ahead of time what events and or preparations each event comprises of and all notices and relevant information for the event or item.

Whilst the dedicated calendar can be passively accessed by the care recipient to check their own profile information, the system will automatically send out all relevant information and remainders to the care recipient via various technology methods before any up-coming event or item due date. This ensures active reminder functionality in keeping care recipient informed and updated.

### BRIEF DESCRIPTION OF THE DRAWINGS

FIG. 1 shows a system framework view of a preferred embodiment according to the invention.

FIG. 2 shows a schematic view of a health care plan template according to a preferred embodiment of the invention.

FIG. 3A shows a schematic view of a managing page of health care plan template according to a first preferred embodiment of the invention.

FIG. 3B shows a schematic view of a managing page of health care plan template according to a second preferred embodiment of the invention.

FIG. 3C shows a schematic view of a managing page of health care plan template according to a third preferred embodiment of the invention.

FIG. 3D shows a schematic view of a managing page of health care plan template according to a fourth preferred embodiment of the invention.

FIG. 4 shows a schematic view of a calendar page according to a preferred embodiment of the invention.

FIG. 5 shows a flow chart according to a preferred embodiment of the invention.

FIG. 6 shows a flow chart according to another preferred embodiment of the invention.

### DETAILED DESCRIPTION OF THE INVENTION

Referring now to the drawings illustrating a preferred embodiment of the invention describes in detail as follow:

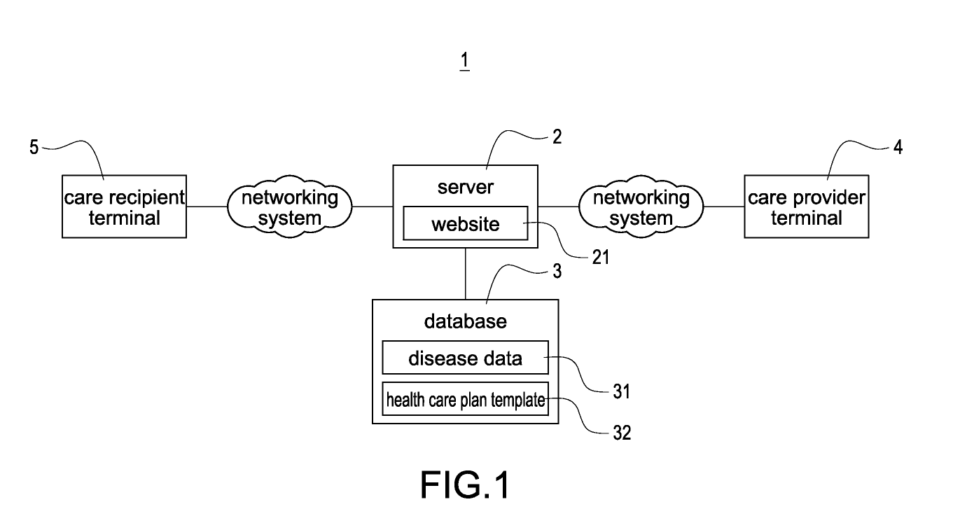

Firstly, please refer to FIG. 1, which is a system framework view according to a preferred embodiment of the invention. As shown in FIG. 1, a managing system 1 for health care plan of the invention comprises a server 2 and a database 3 operatively connected to the server 2. A website 21 is hosted on a server 2 thereon, and the database 3 stores disease data 31 of at least one care recipient and at least one health care plan template 32. A care provider may use a care provider terminal 4 (for example, a computer) to login to the website 21 through a networking system (for example, internet or intranet). After the care provider is authenticated and verified having sufficient access rights, the care provider may perform managing actions such as addition, deletion or modification of data for the health care plan template 32. According to the present invention, after login to the website 21 the care provider can apply a corresponding health care plan template 32 to establish a dedicated health care plan for the disease of a care recipient according to the disease data 31 of the care recipient. In the following embodiment, the care recipient is one of many cared for by the care provider.

Alternatively, a care recipient may use a care recipient terminal 5 (for example, a computer) to login to the website 21 through a networking system. After the care recipient is authenticated and verified having sufficient access rights the care recipient can query the disease data 31 of the care recipient and query at least one health care plan established by the care provider.

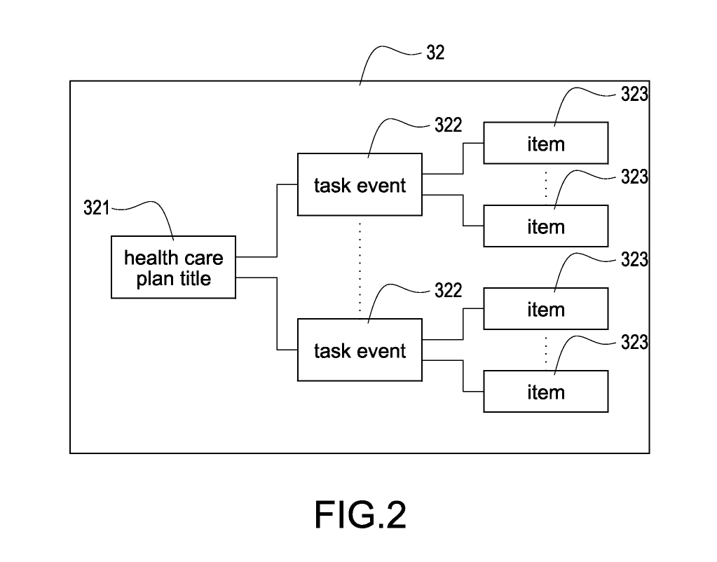

Please refer to FIG. 2, which shows a schematic view of a health care plan template according to a preferred embodiment of the invention. Each of the health care plan templates 32 includes a health care plan title 321, at least one event 322 and at least one item 323. The health care plan title 321 corresponds to each of the disease data 31. Each of the health care plan templates 32 may include a plurality of events 322, and each of the events 322 may respectively include a plurality of items 323. Each of the items 323 respectively corresponds to an item related to the disease data 31. Furthermore, the item 323 also includes notices corresponding to the item, which will be described in detail later.

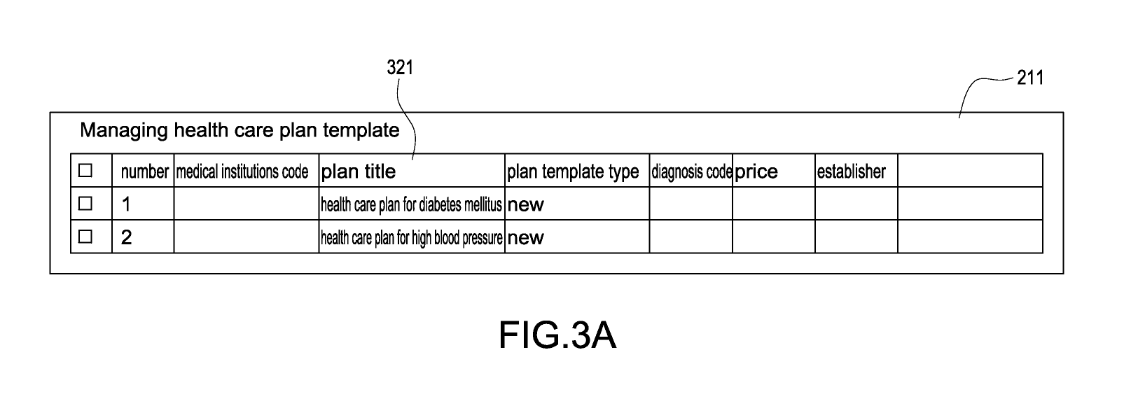

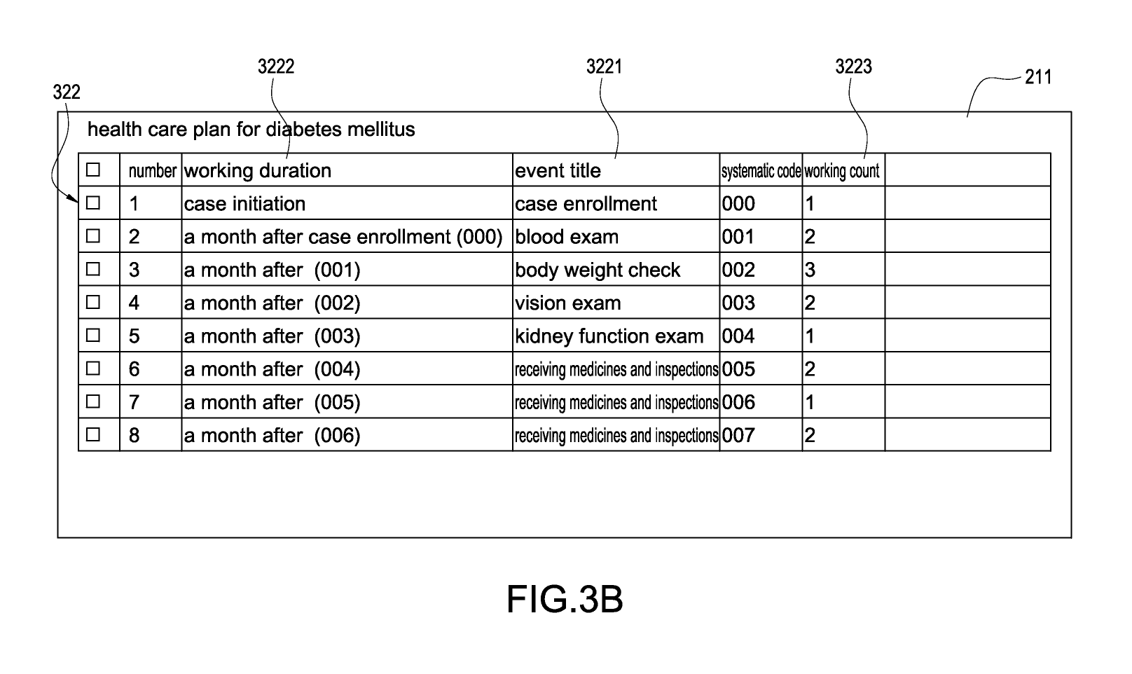

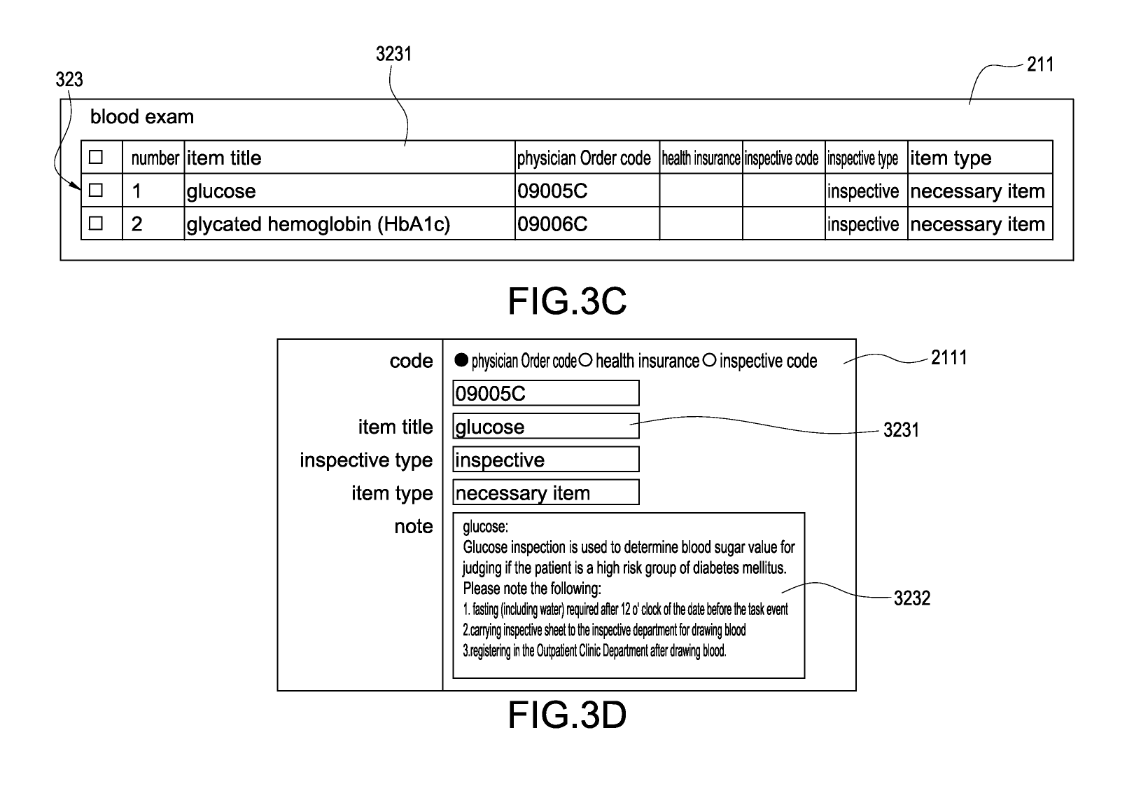

Please also refer to FIG. 3A, FIG. 3B and FIG. 3C, which show schematic views of a managing page of health care plan template according to a first, second and third preferred embodiments of the invention, respectively. The website 21 provides a template-managing page 211, and the user (especially the care provider) may manage the health care plan template 32 through the template-managing page 211 by performing adding, deleting or modification action for at least one of the health care plan template 32, and for at least one of the health care plan title 321, the event 322 and the item 323 in a health care plan template 32.

As shown in FIG. 3A, by taking the health care plan template 32 of diabetes mellitus as an example, the care provider may set the health care plan title 321 as “health care plan for diabetes mellitus” via template management page 211. The health care plan for diabetes mellitus has a plurality of events 322. Each of the events 322 respectively records an event title 3221, a working duration 3222 and a working count 3223.

As shown in FIG. 3B, the health care plan for diabetes mellitus has an event 322 with an event title 3221 of “enrolling a case” (namely, case enrollment) and a plurality of other events 322 with a plurality of event titles 3221 of i.e. “blood exam”, “body weight check”, and the like. The event 322 having the event title 3221 of “enrolling a case” has its working duration 3222 entry showing “case initiation” and working count 3223 of “1.” The events 322 having the event titles 3221 of “blood exam” have the working duration 3222 entry recorded with “a month after case enrollment (000)”; event title 3221 of “body weight check” having working duration 3222 entry recorded with “a month after (001)”; event title 3221 of “vision exam” having working duration 3222 entry recorded with “a month after (002)”; event title 3221 of “kidney function exam” having working duration 3222 entry recorded with “a month after (003)” and the like, and the working count 3223 of “2”, “3”, “2”, and “1” respectively. Please note that even if the events 322 might have the same event title 3221, the events 322 with the same event title 3221 can be corresponding to different items 323 (FIG. 3C). In this situation, those events 322 are different events and may have different working counts 3223.

Each of the events 322 comprises at least one item 323. Each of the items 323 respectively includes an item title 3231 and a notice 3232 (for example the notice 3232 shown in FIG. 3D), wherein each item 323 respectively corresponds to an item related to the disease data 31, and the item title 3231 is the title of the item.

By taking FIG. 3C as an example, the event 322 with the event title 3221 of “blood exam” has two items 323 with the item title 3231 of “glucose” and the item title 3231 of “glycated hemoglobin (HbA1c).” The two items 323 respectively correspond to the item of glucose and the item of HbA1c. The notices 3232 respectively include the reminding information for the two items.

Please also refer to FIG. 3D, it shows a schematic view of a managing page of health care plan template according to a fourth preferred embodiments of the invention. The user may open an editing page 2111 from the managing page 211 of the template to edit the notices 3232 respectively for every item 323. The notice 3232 mainly records the reminding information of the item corresponding to the item 323. For example, the reminding information may include, but not limited to, the purpose of the item, preparations required by care recipient before the item, the location for item, and the subsequent action after the item.

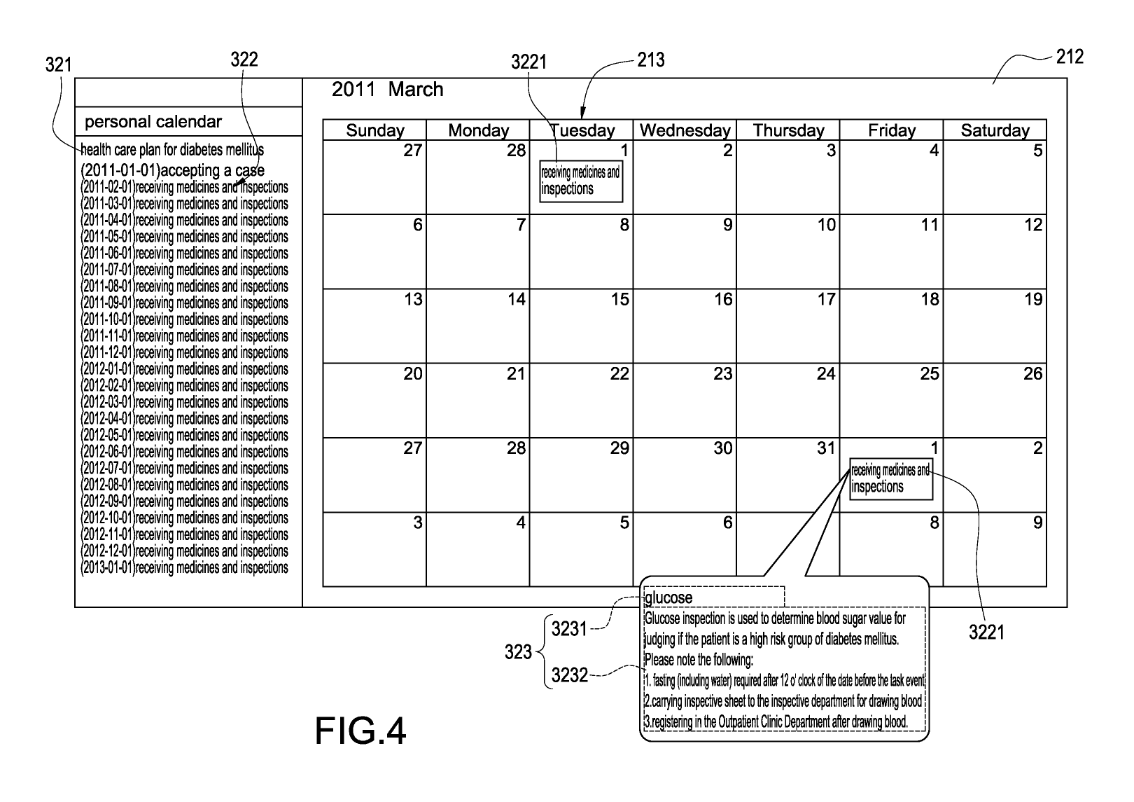

Accordingly, the health care plan template 32 corresponding to the disease data 31 is constituted by the health care plan title 321, the event 322 and the items 323 thereof When a care provider intends to establish a health care plan for a care recipient with a specific disease, the care provider can apply the above health care plan template 32 directly to the care recipient profile, and the health care plan template 32 can be modified accordingly to specific needs and it will be conveniently accessible via calendar 213 by the care provider and the recipient (the calendar 213 as shown in FIG. 4).

Please refer to FIG. 4, which is a schematic view of a calendar page according to a preferred embodiment of the invention. As shown in FIG. 4, the website 21 further provides a calendar page 212 for creating the dedicated calendar 213 of the care recipient. When the user (especially the care provider) login to the website 21 and selects one of the disease data 31 for one care recipient to be managed, the managing system 1 for health care plan automatically selects the health care plan template 32 corresponding to the selected disease data 31 and applies the selected health care plan template 32 to the dedicated calendar 213 of the care recipient (namely, the selected health care plan template 32 can be manifested through the dedicated calendar 213 of the care recipient). The starting date may be set by the care provider or the care recipient and once starting date is set, the health care plan template 32 and the relevant items are displayed on the care recipient calendar 213.

As shown in FIG. 4, the managing system 1 for health care plan displays event titles 3221 of the event 322 on the calendar 213 according to the working duration 3222 of the event 322 of the health care plan template 32. For example, in the FIG. 3B, every event 322 having the event title 3221 of “receiving medicines and inspections” has a time interval of a month, and the starting date of Mar. 1, 2011 is set. Accordingly, the calendar page 212 displays event titles 3221 of the event 322 on the calendar 213 according to the working duration 3222 of a month from Mar. 1, 2011. However, the actual form of the health care plan template 32 displayed on the calendar 213 and the actual time interval of the working cycle 3222 of the event 322 are not limited to above-mentioned example, and can be varied according to practical situation.

Besides displaying the event title 3221 of the event 322, the calendar 213 can also display the items 323 corresponding to the event 322. More specifically, the calendar 213 can further display the item title 3231 and the notice 3232 of the item 323. In this embodiment, the managing system 1 for health care plan displays event titles 3221 of the event 322 on the calendar 213 with the time span beginning from the starting date (Mar. 1, 2011) and based on the working duration 3222 of the event 322. However, the care provider or the care recipient can freely modify the date entry for the produced event 322 at his disposal. Besides the established events 322 of the health care plan template 32, the care provider or the care recipient can further add additional events 322 not established by the health care plan template 32 and or events irrelevant to the health care plan in the calendar 213. Those added events 322 are also displayed on the calendar 213.

More particularly, the care recipient may subscribe to the dedicated calendar 213 through RSS or may import the ical-format calendar 213 into the calendar tools supporting ical format (such as google calendar or outlook). Moreover, upon the subscription by the care recipient, the managing system 1 for health care plan may also remind the care recipient by delivering short message, e-mail or the like to the care recipient before the date for carrying out the event 322 (for example, one day and/or one week before the date for carrying out the event 322). The content of short message or e-mail mainly comprises the event title 3221 and the date of the event 322 as well as the item title 3231 and the notices 3232 of the item 323. However, the above examples are only used to demonstrate the preferred embodiments, and are not to limit the scope of the invention.

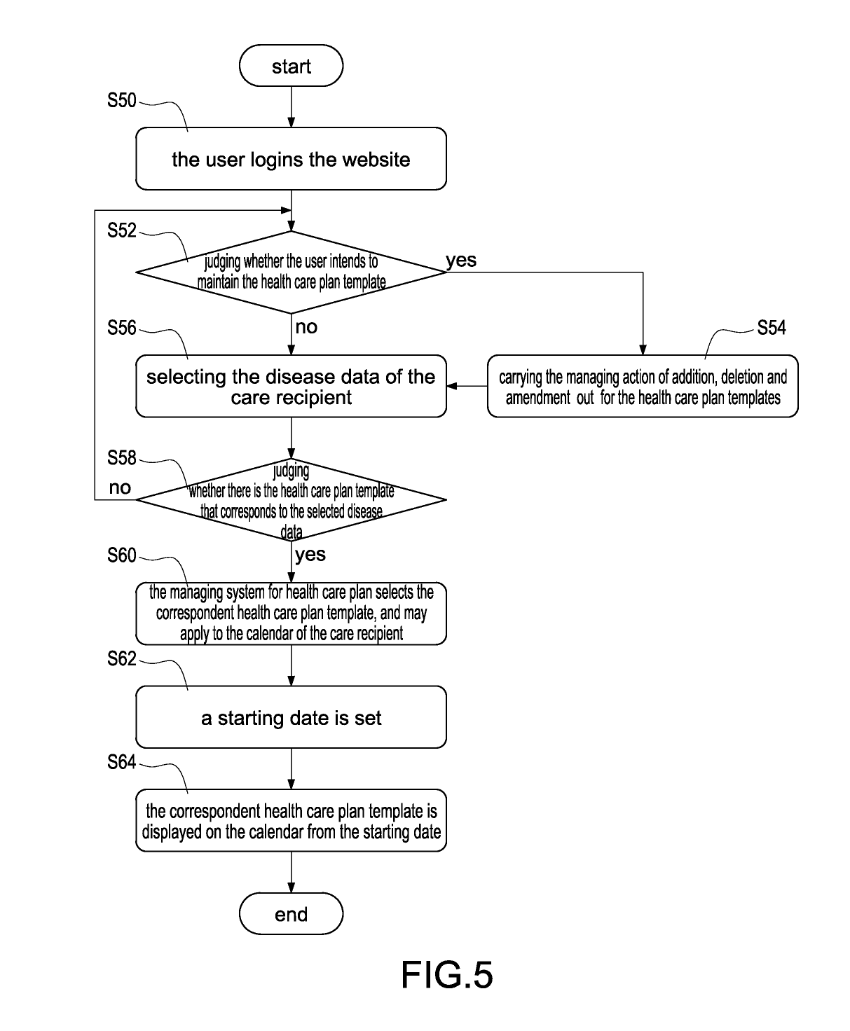

Please refer to FIG. 5, which shows a flow chart according to a preferred embodiment of the invention. At first, the user (the care provider or the care recipient) login to the website 21 (step S50), and then the managing system 1 for health care plan determines whether the user intends to perform maintenance to the health care plan template 32 (step S52). If the user intends to perform maintenance to the health care plan template 32, the user can do so via the template management page 211 to perform actions such as addition, deletion, and or modification to the health care plan template 32 in database 3 (step S54).

Next, the user can select one of the disease data 31 of the care recipient (step S56), and then the managing system 1 for health care plan determines whether a health care plan template 32 corresponding to the selected disease data 31 is already stored (namely, is present) in the database 3 (step S58). If the health care plan template 32 corresponding to the selected disease data 31 of the care recipient is not found in the database 3 in step S58, the system will return back to step S52, and the care provider can create a health care plan template 32 corresponding to the care recipient's disease in the maintenance step S52.

If a health care plan template 32 corresponding to the selected disease data 31 is found in the database 3 in step S58, the managing system 1 for health care plan automatically selects the correspondent health care plan template 32 and applies the selected health care plan template 32 to the calendar 213 of the care recipient (step S60). After step S60, a starting date is set for the health care plan template 32(step S62) and the correspondent health care plan template 32 is displayed on the calendar 213 along with the relevant contents (step S64). More specifically, the calendar 213 is displayed on the calendar page 212 of the website 21 in step S64, wherein at least the event titles 3221 of the event 322 corresponding to the health care plan template 32 are displayed on the calendar 213, and more detailed information for the event titles 3221 of the event 322 can be accessed by, for example, clicking the shown event title 3221 with computer mouse or other pointing device. Moreover, after step S64, while this next step is not in the flowchart, the user can decide whether there is a need to add an additional health care plan for the care recipient. If additional health care plan is needed, the system can return to step S52 to allow user to maintain the health care plan template, or back to step S56 to allow user to select a new disease data.

Moreover, the managing system 1 for health care plan displays the items 323 corresponding to the event 322 on the calendar 213 as shown in FIG. 4. The item 323 includes the item title 3231 and the notice 3232. However, the above-mentioned display manner is only a preferred embodiment of the invention, and is not intended to limit the scope of the invention.

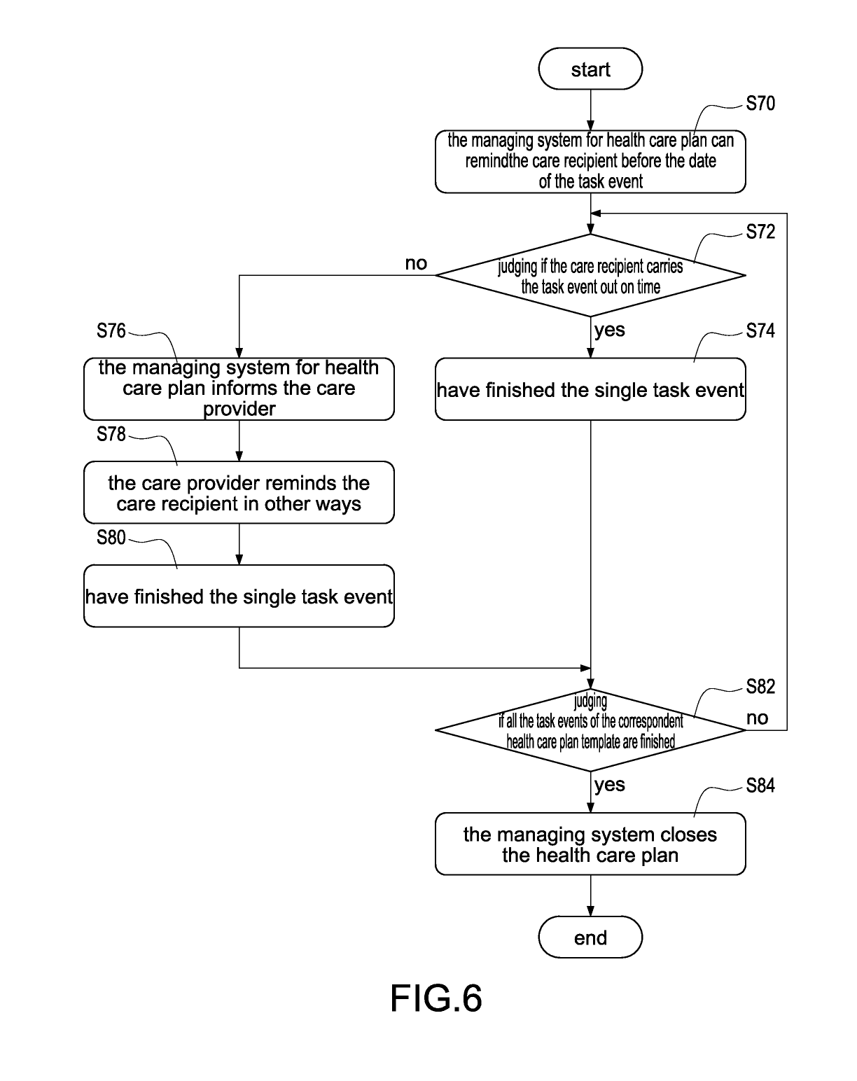

Please refer to FIG. 6, which shows a flow chart according to another preferred embodiment of the invention. If the managing system 1 for health care plan of the invention accepts the subscription from the care recipient in advance, the managing system 1 for health care plan can remind the care recipient before the date of the event 322 (step S70). The managing system 1 for health care plan may deliver short message, e-mail or the like to remind the care recipient before the event date for carrying out the event 322 (for example, one day or one week before the date for carrying out the event 322).

As mentioned above, the content of the short message or e-mail delivered by the managing system 1 for health care plan mainly comprises the event title 3221 and the date of the event 322 as well as the item title 3231 and the notices 3232 of the item 323. Accordingly, the managing system 1 for health care plan can effectively remind the care recipient of the exact time schedule and the detailed information relevant to the events.

Next, the managing system 1 for health care plan determines if the care recipient had carried out the event 322 on time (step S72). If the care recipient was able to carry out the event 322 on time, the managing system 1 will determine that the care recipient has completed the single event 322 (step S74). If the care recipient was not able to carry out the event 322 on time, the managing system 1 will inform the care provider (step S76), and the care provider will take action to reminds the care recipient in other ways (step S78).

Further, after the care recipient finishes the single event 322 (step S80), the managing system 1 for health care plan will validate if all of the events 322 of the correspondent health care plan template 32 are completed (step S82). If not all of the events 322 of the corresponding health care plan template 32 are completed, the system will return back to step S72, where the next action or the reminder of the events 322 are conducted. If all the events 322 of the corresponding health care plan template 32 are completed, the managing system 1 for health care plan will close the health care plan (step S84).

The invention is not limited to these embodiments, but various variations and modifications may be made without departing from the scope of the invention.

What is claimed is:

1. A managing system for health care plan, comprising:
a server hosting a website, the website having a calendar page for producing and displaying at least one dedicated calendar of a care recipient; and
a database operatively connected to the server, the database storing at least one disease data of the care recipient and at least one health care plan template,
when an authenticated user login to the managing system for health care plan and chooses one of the disease data for the care recipient, the managing system automatically selects the health care plan template corresponding to the chosen disease data and applies the health care plan template to a calendar of the care recipient,
wherein the calendar of the care recipient is configured to display the corresponding health care plan template from a starting date.

2. The managing system for health care plan as claimed in claim 1, wherein the health care plan template 32 includes a health care plan title corresponding to the disease data, at least one event comprising an event title, a working duration and a working count; and at least one item recording an item title and a notice,

3. The managing system for health care plan as claimed in claim 2, wherein the calendar page is configured to display the event titles of the event corresponding to the health care plan template on the calendar.

4. The managing system for health care plan as claimed in claim 3, wherein the calendar page is configured to display the item corresponding to the event, the item including the item title and the notice on the calendar.

5. The managing system for health care plan as claimed in claim 2, wherein the website comprises a managing page of the template, and the managing page of the template is accessible by a user to add, delete or modify at least one of the health care plan templates, and to add, delete or modify at least one of the event title, the event and the item for at least one of the health care plan templates.

6. A managing method for health care plan, the method applied in a managing system for health care plan, the managing system comprising a server hosting a website and a database operatively connected to the server, the database storing at least one health care plan template and at least one disease data of a care recipient, the managing method for health care plan comprising steps of:
(a) authenticating login to access the website;
(b) choosing the disease data of the care recipient;
(c) determine whether a health care plan template corresponding to the selected disease data is present in the database;
(d) after step (c), if the health care plan template corresponding to the selected disease data is present in the database, the managing system for health care plan selects the correspondent health care plan template and applies the selected health care plan template to a dedicated calendar of the care recipient
(e) setting a starting date; and
(f) displaying the correspondent health care plan template on the dedicated care recipient calendar with dates beginning from the starting date.

7. The managing method for health care plan as claimed in claim 6, wherein step (f) displays the event titles of each of the event(s) corresponding to the health care plan template on the calendar.

8. The managing method for health care plan as claimed in claim 7, wherein step (f) displays items corresponding to the events on the calendar, each of the items including an item title and a notice, and each of the items respectively corresponding to an item related to the disease data.

9. The managing method for health care plan as claimed in claim 6, further including steps of:
(g) reminding the care recipient before a date for carrying out the event of the health care plan template;
(h) determine if the care recipient had carried out the event on time; and
(i) after step (h), if the care recipient fails to carry out the event on time, the managing system for health care plan informs the care provider, and the care provider will notify the care recipient via other means.

10. The managing method for health care plan as claimed in claim 9, wherein the step (g) reminds the care recipient by delivering short message or e-mail, the content of the short message or e-mail comprising the event title and the date of the event as well as the item title and the notice of the item.

11. The managing method for health care plan as claimed in claim 9, further including steps of:
(j) determine if all of the events of the correspondent health care plan template are completed; and
(k) after the step (j), if all the events of the correspondent health care plan template are completed, the managing system for health care plan closes the health care plan.
